(19) United States
(12) Patent Application Publication
(10) Pub. No.: US 2013/0058741 A1
(43) Pub. Date: Mar. 7, 2013

(54) HANDLER AND PART INSPECTION APPARATUS

(71) Applicants: Hiroaki FUJIMORI, Suwa (JP); Toshioki SHIMOJIMA, Suwa (JP); Nobuo HASEGAWA, Azumino (JP)

(72) Inventors: Hiroaki FUJIMORI, Suwa (JP); Toshioki SHIMOJIMA, Suwa (JP); Nobuo HASEGAWA, Azumino (JP)

(73) Assignee: SEIKO EPSON CORPORATION, Tokyo (JP)

(21) Appl. No.: 13/605,402

(22) Filed: Sep. 6, 2012

(30) Foreign Application Priority Data
Sep. 7, 2011 (JP) 2011-195435

(51) Int. Cl. B65G 49/00

(52) U.S. Cl. 414/225.01

(57) ABSTRACT

A handler includes at least one transport section which transports a transport target onto a base. The transport section includes a plurality of first elevating sections which respectively move up and down a plurality of gripping sections which grip the transport target, and a single second elevating section which moves up and down all the plurality of first elevating sections. In connection of the transport target to a connection destination, a part of the plurality of first elevating sections are driven to descend, and the remaining part thereof are driven to ascend.

### BACKGROUND

1. Technical Field

The present invention relates to a handler which transports a transport target and a part inspection apparatus including the handler.

2. Related Art

In general, in a part inspection apparatus which inspects electrical characteristics of electronic parts, a handler is used which transports electronic parts before inspection or after inspection between a predetermined tray and an inspection socket. As such a handler, for example, as disclosed in JP-A-2002-148307, a handler is known which includes two transport units which transport electronic parts from a predetermined position to an inspection socket and then insert the electronic parts into the inspection socket.

In the handler disclosed in JP-A-2002-148307, while one transport unit presses the electronic parts on the inspection socket and a tester provided in a part inspection apparatus performs inspection, the other transport unit ejects the electronic parts after inspection and supplies the electronic parts before inspection, so that two transport units alternately supply the electronic parts for inspection. However, in such a handler, since the time when the other transport unit performs ejection and supply of the electronic parts is longer than the time when one transport unit supplies the electronic parts for inspection, it is difficult to efficiently perform inspection of the electronic parts in the part inspection apparatus.

Further, in the related art, a handler as shown in FIGS. 18A to 18C is proposed, for example. FIGS. 18A to 18C are side views illustrating a side structure of a handler, which show a transport unit which grips electronic parts corresponding to four times the number of electronic parts capable of being treated at a time by a tester.

As shown in FIG. 18A, four elevating mechanisms 100a to 100d which are able to independently ascend and descend are arranged in one direction in a transport unit 100, and electronic parts 110a to 110d of which the number is capable of being treated at a time by a tester are gripped by respective lower ends of four elevating mechanisms. Further, as shown in FIG. 18B, firstly, the elevating mechanism 100a on the front side in the arrangement direction of the elevating mechanisms, among four elevating mechanisms, moves down its lower end and presses the electronic part 110a to insert into an inspection socket 120, thereby supplying the electronic part 110a for inspection. Then, if the inspection of the electronic part 110a is complete, the elevating mechanism 100a which grips the electronic part 110a ascends, and as shown in FIG. 18C, the entire transport unit 100 moves in the horizontal direction so that another elevating mechanism 100b adjacent to the front elevating mechanism 100a is disposed directly above the inspection socket 120. Subsequently, the electronic part 110b is supplied for inspection as the elevating mechanism 100b descends. Then, with respect to the other elevating mechanisms 100c and 100d, the same operations are repeated. Accordingly, without intervention of ejection or supply of the electronic parts on the way in the transport unit, it is possible to supply electronic parts of a plurality of inspection units which are different from each other for inspection by one transport unit. Further, by using a handler including such a plurality of transport units in a part inspection apparatus, it is possible to enhance inspection efficiency in the part inspection apparatus.

However, in the handler shown in FIGS. 18A to 18C, it is necessary to install a mechanism which moves up and down the lower end of the elevating mechanism over a predetermined range in each of four elevating mechanisms. Further, it is necessary to install a mechanism which presses the electronic part with a large force of such a degree that the electronic part gripped by the elevating mechanism is inserted into the inspection socket, in each of four elevating mechanisms. Thus, the entire configuration of the elevating mechanism in the elevating direction is necessarily complicated, and it is difficult to avoid increase in the size or weight of the transport unit, which consequently results in decrease in the movement speed of the transport unit and decrease in the transport efficiency at the time of transport of the electronic parts. This problem is common to handlers including the transport unit as shown in FIGS. 18A to 18C, regardless of the number of the transport units.

### SUMMARY

An advantage of some aspects of the invention is to provide a handler which is able to efficiently transport a transport target with a simple configuration, and a part inspection apparatus including the handler.

An aspect of the invention is directed to a handler including at least one transport section which transports a transport target onto a base, wherein the transport section includes: a plurality of first elevating sections which are respectively connected to a plurality of gripping sections which grip the transport target, and respectively move up and down the plurality of gripping sections with respect to the base; and a single second elevating section which is connected to all the plurality of first elevating sections and moves up and down the plurality of connected first elevating sections with respect to the base.

According to the aspect of the invention, since one second elevating section moves up and down the plurality of first elevating sections, on the assumption that an elevating range of the transport target is maintained, the configuration of the transport section becomes simple. Further, it is possible to decrease the size or weight of the transport section, and thus, it is possible to enhance the movement speed of the transport section when the transport target is transported and to efficiently transport the transport target.

According to another aspect of the invention, the handler includes a control section which controls transport of the transport section, and the control section drives a part of the plurality of first elevating sections to descend and drives the remaining part thereof to ascend.

According to this aspect of the invention, compared with an elevation state where the remaining part of the first elevating sections is driven to descend or is not driven, the respective positions of the plurality of first elevating sections are spaced from each other in the elevating direction. Thus, even in a case where a portion which interferes with descent of one gripping section in a direction where the specific gripping section descends is present on the base, only the one gripping section can be driven to ascend, and the other gripping sections can be driven to descend, to avoid interference with such a portion. Thus, it is possible to transport the transport target even to a portion where the above-described interference occurs, and thus, it is possible to increase a range where the transport target can be transported on the base.

According to still another aspect of the invention, the handler includes a control section which controls transport of the transport section, the transport section includes four or more first elevating sections, and the control section drives the plurality of first elevating sections so that elevating states of the first elevating sections which are adjacent to each other are different from each other.

According to this aspect of the invention, even in a case where a plurality of portions on the base which are a destination of descent of the transport target are arranged at intervals, if such an interval corresponds to the width of one first elevating section, it is possible to move down the transport targets at a time to the plurality of portions which correspond to such a descent destination. Thus, it is possible to efficiently transport the transport target.

According to yet another aspect of the invention, each of the first elevating sections and the second elevating section is driven by an individual motor.

According to this aspect of the invention, by electrically driving the first elevating sections and the second elevating section by the motors, it is possible to perform high-speed driving or arch driving, with respect to driving of the respective sections of the transport section. Thus, it is possible to efficiently transport the transport target.

According to still yet another aspect of the invention, the handler includes a control section which controls transport of the transport section, and two transport sections, and until a connection operation of the transport target to a connection destination of the transport target through one transport section is terminated, the control section makes the other transport section be adjacent to the one transport section in standby.

According to this aspect of the invention, it is possible for two transport sections to continuously connect the transport targets to the connection destinations, and thus, it is possible to efficiently transport the transport target. Further another aspect of the invention is directed to a part inspection apparatus including a tester which has an inspection socket installed in an opening portion of a base and at least one transport section which transports an electronic part to the inspection socket on the base, wherein the transport section includes: a plurality of first elevating sections which are respectively connected to a plurality of gripping sections which grip the electronic part and respectively move up and down the plurality of gripping sections with respect to the inspection socket; and a single second elevating section which is connected to all the plurality of first elevating sections and moves up and down all the plurality of first elevating sections with respect to the inspection socket.

According to this aspect of the invention, with respect to the transport section provided in the part inspection apparatus, since one second elevating section moves up and down the plurality of first elevating sections, on the assumption that an elevating range of the electronic part is maintained, the configuration of the transport section becomes simple. Further, it is possible to decrease the size or weight of the transport section, and thus, it is possible to enhance the movement speed of the transport section when the electronic parts are transported. Thus, it is possible to efficiently transport the electronic parts and to enhance inspection efficiency of the part inspection apparatus.

### BRIEF DESCRIPTION OF THE DRAWINGS

The invention will be described with reference to the accompanying drawings, wherein like numbers reference like elements.

FIG. 1 is a view illustrating an entire configuration of apart inspection apparatus which is mounted with a handler according to a first embodiment of the invention.

FIG. 2 is an end view schematically illustrating an end structure of the handler according to the first embodiment.

FIG. 3 is a block diagram illustrating an electric configuration of the handler according to the first embodiment.

FIG. 4A is a timing chart illustrating transition of the position of a transport unit in the Y direction, FIG. 4B is a timing chart illustrating transition of the position of a first elevating mechanism in the Z direction, and FIGS. 4C and 4D are timing charts illustrating transition of the position of a gripping section in the Z direction, with respect to an operation state in the handler according to the first embodiment.

FIG. 5 is an end view illustrating arrangement of transport units in an operation state according to the first embodiment.

FIG. 6 is an end view illustrating arrangement of the transport units in an operation state according to the first embodiment.

FIG. 7 is an end view illustrating arrangement of the transport units in an operation state according to the first embodiment.

FIG. 8 is an end view illustrating arrangement of the transport units in an operation state according to the first embodiment.

FIG. 9 is an end view illustrating arrangement of the transport units in an operation state according to the first embodiment.

FIG. 10 is an end view illustrating arrangement of the transport units in an operation state according to the first embodiment.

FIG. 11 is an end view illustrating arrangement of the transport units in an operation state according to the first embodiment.

FIG. 12 is an end view illustrating arrangement of the transport units in an operation state according to the first embodiment.

FIG. 13 is an end view illustrating arrangement of the transport units in an operation state according to the first embodiment.

FIG. 14 is an end view illustrating arrangement of transport units in an operation state of a handler according to a second embodiment of the invention.

FIG. 15 is an end view illustrating arrangement of the transport units in an operation state of a handler according to the second embodiment.

FIG. 16 is an end view illustrating arrangement of the transport units in an operation state of a handler according to the second embodiment.

FIG. 17 is an end view illustrating arrangement of the transport units in an operation state of a handler according to the second embodiment.

FIGS. 18A to 18C are end views illustrating arrangement of a transport unit in an operation state of a handler in the related art.

### DESCRIPTION OF EXEMPLARY EMBODIMENTS

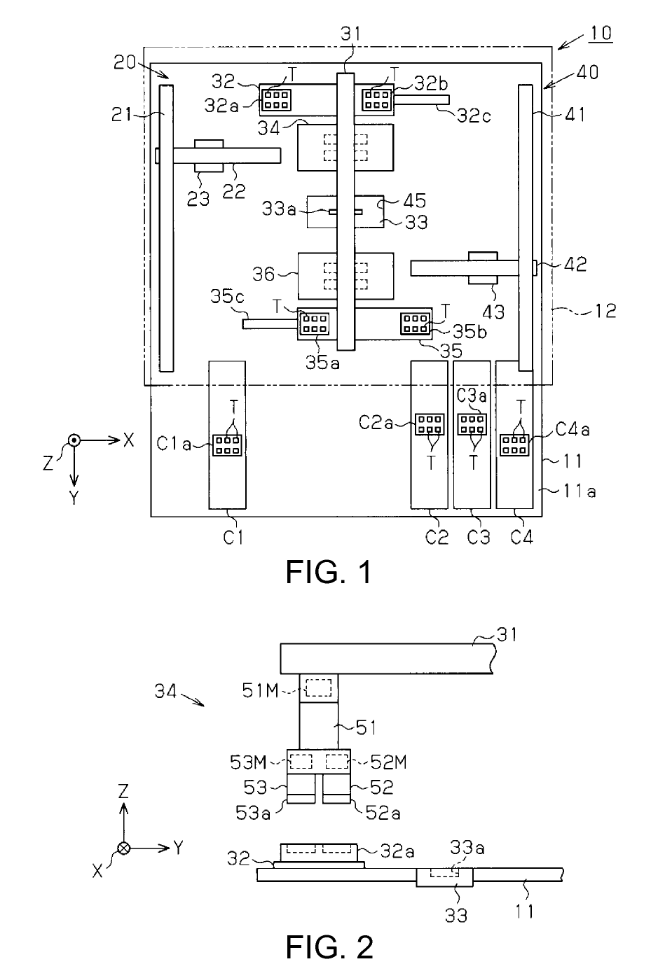

Hereinafter, a first embodiment in which a handler and a part inspection apparatus of the invention are specified will be described with reference to FIG. 1 to FIG. 13. Firstly, configurations of the handler and the part inspection apparatus which includes the handler will be described with reference to FIGS. 1 and 2.

### Configuration of Handler and Part Inspection Apparatus

As shown in FIG. 1, on a base 11 of a handler 10, a mounting surface 11a on which various robots are mounted is provided as an upper surface, and most of the mounting surface 11a is covered by a cover member 12. A transport space which is a space surrounded by the cover member 12 and the mounting surface 11a has temperature and moisture which are maintained at predetermined values by dry air supplied from the outside. On the mounting surface 11a of the base 11, four conveyors which extend in one direction are arranged in a direction orthogonal to a transport direction of the conveyors. Among four conveyors, one supply conveyor C1 is installed on one side in the X direction which is the array direction of the conveyors, and three recovery conveyors C2, C3 and C4 are installed on the other side in the X direction. Further, in the supply conveyor C1, a supply conveyor tray C1a moves toward the inside from the outside of the cover member 12. Further, in the recovery conveyors C2, C3 and C4, recovery conveyor trays C2a, C3a and C4a move toward the outside from the inside of the cover member 12. A plurality of electronic parts T before inspection which are transport targets are accommodated in the supply conveyor tray C1a, and a plurality of electronic parts T after inspection are accommodated in the recovery conveyor trays C2a, C3a and C4a. Three rows of electronic parts T in the X direction and two rows of electronic parts T in the Y direction are accommodated in a matrix form in the supply conveyor tray C1a and the recovery conveyor trays C2a, C3a and C4a according to the present embodiment.

A supply robot 20 and a recovery robot 40 which face each other in the X direction are mounted on the mounting surface 11a of the base 11. The supply robot 20 is disposed on the side of the supply conveyor C1 in the Y direction, and the recovery robot 40 is disposed on the side of the recovery conveyors C2, C3 and C4 in the Y direction.

The supply robot 20 includes a fixed supply guide 21 which is a fixed shaft which extends in the Y direction, a movable supply guide 22 which is a movable shaft which is connected to the fixed supply guide 21, and a supply hand unit 23 which is connected to the movable supply guide 22 and moves along the movable supply guide 22.

The movable supply guide 22 is a movable shaft which extends to the side of the recovery robot 40 from the fixed supply guide 21, and is connected to the fixed supply guide 21 to be able to reciprocate in the Y direction. The supply hand unit 23 is an end effector which is disposed on the side of the mounting surface 11a of the movable supply guide 22, and is connected to the movable supply guide 22 to be able to reciprocate in the X direction. Further, the supply hand unit 23 is connected to the movable supply guide 22 to be able to descend from the movable supply guide 22 to the mounting surface 11a and to ascend from the side of the mounting surface 11a to the movable supply guide 22.

Further, the movable supply guide 22 moves to the side of the supply conveyor C1 along the fixed supply guide 21, and the supply hand unit 23 moves to the upside of the supply conveyor tray C1a along the movable supply guide 22. Accordingly, the electronic parts T which are mounted on the supply conveyor tray C1a are adhered to a suction pad of the supply hand unit 23, and then are lifted from the supply conveyor tray C1a. Further, as the movable supply guide 22 moves away from above the supply conveyor C1 along the fixed supply guide 21 from this state, the electronic parts T adhered to the supply hand unit 23 are supplied to a predetermined position in the above-mentioned transport space. The supply hand unit 23 in the present embodiment adheres to and holds a plurality of electronic parts at the same time.

The recovery robot 40 includes a fixed recovery guide 41 which is a fixed shaft which extends in the Y direction, a movable recovery guide 42 which is a movable shaft connected to the fixed recovery guide 41, and a recovery hand unit 43 which is connected to the movable recovery guide 42 and moves in the X direction along the movable recovery guide 42, in a similar way to the supply robot 20.

The movable recovery guide 42 is a movable shaft which extends to the side of the supply robot 20 from the fixed recovery guide 41, and is connected to the fixed recovery guide 41 to be able to reciprocate in the Y direction. The recovery hand unit 43 is an end effector which is disposed on the side of the mounting surface 11a of the movable recovery guide 42, and is connected to the movable recovery guide 42 to be able to reciprocate in the X direction. Further, the recovery hand unit 43 is connected to the movable recovery guide 42 to be able to descend from the movable recovery guide 42 to the mounting surface 11a and to ascend from the side of the mounting surface 11a to the movable recovery guide 42.

Further, the movable recovery guide 42 moves to the side of the recovery conveyors C2, C3 and C4 along the fixed recovery guide 41, and the recovery hand unit 43 moves to the upside of the recovery conveyor trays C2a, C3a and C4a along the movable recovery guide 42. Accordingly, the electronic parts T which are adhered to a suction pad of the recovery hand unit 43 are mounted onto the recovery conveyor trays C2a, C3a and C4a. The recovery hand unit 43 in the present embodiment adheres to and holds a plurality of electronic parts at the same time, in a similar way to the supply hand unit 23. Further, on the inside surface of the cover member 12, a transport guide 31 which extends in the Y direction is fixed at approximately the center of the inside surface in the X direction. A first shuttle 32 which extends in the X direction and a second shuttle 35 which extends in the X direction are disposed under the opposite end portions of the transport guide 31.

The first shuttle 32 is connected to a first shuttle guide 32c which extends in the X direction and is fixed on the mounting surface 11a and reciprocates along the X direction. A supply shuttle tray 32a which is a first supply tray is fixed on the side of the supply robot 20 in the first shuttle 32, and a recovery shuttle tray 32b which is a first recovery tray is fixed on the side of the recovery robot 40 in the first shuttle 32. A plurality of electronic parts T before inspection which are transport targets are accommodated in the supply shuttle tray 32a, and a plurality of electronic parts T after inspection are accommodated in the recovery shuttle tray 32b.

Further, the first shuttle 32 is disposed at a supply position which is a position where the supply shuttle tray 32a is disposed under the movable supply guide 22 and the recovery shuttle tray 32b is disposed under the transport guide 31. Further, the first shuttle 32 is also disposed at a recovery position which is a position where the supply shuttle tray 32a is disposed under the transport guide 31 and the recovery shuttle tray 32b is disposed under the movable recovery guide 42. Further, the first shuttle 32 reciprocates along the X direction between the supply position and the recovery position. That is, the first shuttle 32 reciprocates between the supply position where the electronic parts T may be supplied to the supply shuttle tray 32a by the supply hand unit 23 and the recovery position where the electronic parts may be recovered from the recovery shuttle tray 32b by the recovery hand unit 43.

Further, the second shuttle 35 is connected to a second shuttle guide 35c which extends in the X direction and is fixed on the mounting surface 11a and reciprocates along the X direction. A supply shuttle tray 35a which is a second supply tray is fixed on the side of the supply robot 20 in the second shuttle 35, and a recovery shuttle tray 35b which is a second recovery tray is fixed on the side of the recovery robot 40 in the second shuttle 35. A plurality of electronic parts T before inspection which are transport targets are accommodated in the supply shuttle tray 35a, and a plurality of electronic parts T after inspection are accommodated in shuttle tray 35b. Further, the second shuttle 35 is disposed at a supply position which is a position where the supply shuttle tray 35a is disposed under the movable supply guide 22 and the recovery shuttle tray 35b is disposed under the transport guide 31. Further, the second shuttle 35 is also disposed at a recovery position which is a position where the supply shuttle tray 35a is disposed under the transport guide 31 and the recovery shuttle tray 35b is disposed under the movable recovery guide 42. Further, the second shuttle 35 reciprocates along the X direction between the supply position and the recovery position.

That is, the second shuttle 35 reciprocates between the supply position where the electronic parts T may be supplied to the supply shuttle tray 35a by the supply hand unit 23 and the recovery position where the electronic parts T may be recovered from the recovery shuttle tray 35b by the recovery hand unit 43.

Further, on the supply shuttle trays 32a and 35a and the recovery shuttle trays 32b and 35b in the present embodiment, three rows of electronic parts T in the X direction and two rows of electronic parts T in the Y direction are accommodated in a matrix form. That is, the supply shuttle trays 32a and 35a respectively receive the supply of the electronic parts T once by the supply hand unit 23 to be fully mounted with the electronic parts T. Further, the recovery shuttle trays 32b and 35b respectively receive the recovery of the electronic parts T once by the recovery hand unit 43 to recover all the electronic parts T.

Further, at approximately the center of the transport space on the mounting surface 11a, a rectangular opening portion 45 is formed through the mounting surface 11a. A test head 33 of a tester provided in the part inspection apparatus is installed in the opening portion 45. The test head 33 has an inspection socket in which the electronic parts T are inserted on an upper surface thereof, and is electrically connected to an inspection circuit in the tester for inspecting the electronic parts T.

Inspection pockets 33a capable of simultaneously accommodating three rows of electronic parts T in the X direction and one row of electronic parts T in the Y direction are concavely installed in the inspection socket installed on the upper surface of the test head 33, and a plurality of female terminals capable of fitting to male terminals of the electronic parts T are installed on lower surfaces of the inspection pockets 33a. Further, as the male terminals included in the electronic parts T fit to the female terminals of the inspection pockets 33a, it is possible to inspect electrical characteristics of the electronic parts T by the tester. The tester receives an electric signal indicating inspection starting from the handler 10 to start inspection of the electronic parts T, and then outputs the inspection result to the handler 10.

Further, a first transport unit 34 which is a transport section and a second transport unit 36 which is a transport section are connected to the transport guide 31.

Configurations of the first transport unit 34 and the second transport unit 36 will be described with reference to FIG. 2. Since the first transport unit 34 and the second transport unit 36 are the same in that the electronic parts T are elevated with two different elevating sections while shuttles which correspond to connection positions or movement destinations in the transport guide 31 are different from each other, the configuration of the first transport unit 34 will be mainly described, and description about an overlap of the configuration of the second transport unit 36 with the first transport unit 34 will be omitted. Further, FIG. 2 is an end view illustrating a peripheral structure of the first transport unit 34, when seen from the side of the supply robot 20, and shows a state where the first transport unit 34 is disposed directly above the first shuttle 32.

As shown in FIG. 2, a second elevating mechanism 51 is connected to be able to reciprocate along the transport guide 31 in the transport guide 31. A plate-shaped connection portion which is widened along the mounting surface 11a is formed in a lower end section of the second elevating mechanism 51, and two first elevating mechanisms 52 and 53 are commonly connected to the connection portion on the side of the mounting surface 11a. First elevating motors 52M and 53M which are respectively drive sources of two first elevating mechanisms 52 and 53 are installed in the connection portion which is the lower end portion of the second elevating mechanism 51. Further, as the first elevating motor 52M rotates forward or reversely, the lower end portion of the first elevating mechanism 52 ascends or descends with respect to the base 11, and as the first elevating motor 53M rotates forward or reversely, the lower end portion of the first elevating mechanism 53 ascends or descends with respect to the base 11.

A second elevating motor 51M which is a drive source of the second elevating motor 51 is installed in an upper portion of the second elevating mechanism 51. Further, as the second elevating motor 51M rotates forward or reversely, the lower end portion of the second elevating mechanism 51 ascends or descends with respect to the base 11. That is, as the second elevating motor 51M is driven, the entire of two first elevating motors 52M and 53M and two first elevating mechanisms 52 and 53 ascends or descends.

Gripping sections 52a and 53a which are end effectors capable of adhering the electronic parts T by vacuum suction for gripping, for example, are connected to the lower end portions of the two first elevating mechanisms 52 and 53, respectively. The gripping sections 52a and 53a are connected to nozzles, a suction pump connected to the nozzles, leak valves which supply compressed air to the nozzles, and the like, for example. Further, in the present embodiment, each of the gripping sections 52a and 53a is configured to be able to simultaneously grip three rows of electronic parts T in the X direction and one row of electronic parts T in the Y direction. That is, the first transport unit 34 includes two gripping sections 52a and 53a, and thus, can grip the electronic parts T corresponding to two times the number of electronic parts capable of being inspected by the tester at a time.

A first transport section is configured by the second elevating mechanism 51, the second elevating motor 51M, the first elevating mechanisms 52 and 53, and the first elevating motors 52M and 53M. Further, a second elevating section in the first transport section is configured by the second elevating mechanism 51 and the second elevating motor 51M, and a first elevating section in the first transport section is configured by the first elevating mechanisms 52 and 53 and the first elevating motors 52M and 53M.

Further, a second transport section is configured by a second elevating mechanism, a second elevating motor, first elevating mechanisms, and first elevating motors in the second transport unit. Further, a second elevating section in the second transport section is configured by the second elevating mechanism and the second elevating motor in the second transport unit, and a first elevating section in the second transport section is configured by the first elevating mechanisms and the first elevating motors in the second transport unit.

### Electric Configurations of Handler and Part Inspection Apparatus

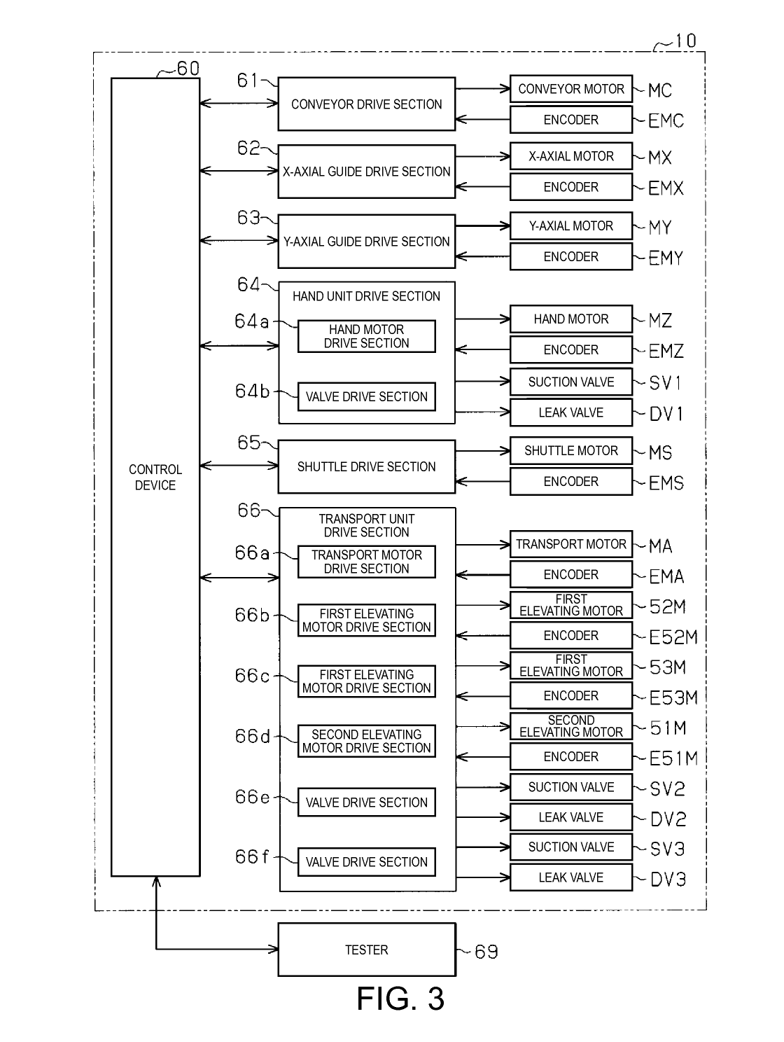

Next, with respect to electric configurations of the handler and the part inspection apparatus, the electric configuration of the handler 10 will be mainly described with reference to FIG. 3. A control device 60 which forms a control section provided in the handler 10 is mainly configured by a microcomputer which includes a central processing unit (CPU), a non-volatile memory (ROM), and a volatile memory (RAM). The control device 60 performs a variety of controls relating to operations of the handler 10 on the basis of various data and programs stored in the ROM and the RAM.

A conveyor drive section 61 which drives a conveyor motor MC to rotate is electrically connected to the control device 60. An encoder EMC which detects the rotation position of the conveyor motor MC is connected to the conveyor drive section 61. The conveyor drive section 61 generates a driving current of the conveyor motor MC on the basis of a position command input from the control device 60 and the rotation position of the conveyor motor MC input from the encoder EMC, and outputs the driving current to the conveyor motor MC. The conveyor motor MC rotates according to the driving current, to drive the conveyors C1 to C4. The conveyor drive section 61 and the conveyor motor MC are installed to each of the conveyors C1 to C4, and the encoder EMC is installed to each conveyor motor MC. That is, the control device 60 controls the operations of the respective conveyors C1 to C4 in an independent manner. Further, an X-axial guide drive section 62 which drives an X-axial motor MX to rotate is electrically connected to the control device 60. An encoder EMX which detects the rotation position of the X-axial motor MX is connected to the X-axial guide drive section 62. The X-axial guide drive section 62 generates a driving current of the X-axial motor MX on the basis of a position command input from the control device 60 and the rotation position input from the encoder EMX, and outputs the driving current to the X-axial motor MX. The X-axial motor MX rotates according to the input driving current, to reciprocate the hand units 23 and 43 along the movable guides 22 and 42. The X-axial guide drive section 62 and the X-axial motor MX are installed to each of the supply hand unit 23 and the recovery hand unit 43, respectively, and the encoder EMX is installed to each X-axial motor MX.

A Y-axial guide drive section 63 which drives a Y-axial motor MY to rotate is electrically connected to the control device 60. An encoder EMY which detects the rotation position of the Y-axial motor MY is connected to the Y-axial guide drive section 63. The Y-axial guide drive section 63 generates a driving current of the Y-axial motor MY on the basis of a position command input from the control device 60 and the rotation position input from the encoder EMY, and outputs the driving current to the Y-axial motor MY. The Y-axial motor MY rotates according to the input driving current, to reciprocate the movable guides 22 and 42 along the fixed guides 21 and 41. The Y-axial guide drive section 63 and the Y-axial motor MY are installed to each of the movable supply guide 22 and the movable recovery guide 42, and the encoder EMY is installed to each Y-axial motor MY.

A hand unit drive section 64 which includes a hand motor drive section 64a and a valve drive section 64b is connected to the control device 60. Here, an encoder EMZ which detects the rotation position of a hand motor MZ is connected to the hand motor drive section 64a. The hand motor drive section 64a generates a driving current of the hand motor MZ on the basis of a position command input from the control device 60 and the rotation position input from the encoder EMZ, and outputs the driving current to the hand motor MZ. The hand motor MZ rotates according to the input driving current, to move up and down the hand units 23 and 43.

A suction valve SV1 and a leak valve DV1 which are installed at the tip ends of the hand units 23 and 43 are connected to the valve drive section 64b. The valve drive section 64b generates a driving signal of the suction valve SV1 on the basis of an opening/closing command of the suction valve SV1 input from the control device 60, and outputs the driving signal to the suction valve SV1. The suction valve SV1 performs an opening/closing operation according to the input driving signal, to thereby suction the electronic parts T using a predetermined suction force. Further, the valve drive section 64b generates a driving signal of the leak valve DV1 on the basis of an opening/closing command of the leak valve DV1 input from the control device 60, and outputs the driving signal to the leak valve DV1. The leak valve DV1 performs an opening/closing operation according to the input driving signal, to thereby transfer compressed air through a suction pad. The hand unit drive section 64, the hand motor MZ, the suction valve SV1 and the leak valve DV1 are installed to each of the supply hand unit 23 and the recovery hand unit 43, and the encoder EMZ is installed to each hand motor MZ. That is, the control device 60 controls an operation of the supply hand unit 23 and an operation of the recovery hand unit 43 in an independent manner.

Further, a shuttle drive section 65 which drives a shuttle motor MS to rotate is connected to the control device 60. An encoder EMS which detects the rotation position of a shuttle motor MS is connected to the shuttle drive section 65. The shuttle drive section 65 generates a driving current of the shuttle motor MS on the basis of a position command input from the control device 60 and the rotation position input from the encoder EMS, and outputs the driving current to the shuttle motor MS. The shuttle motor MS rotates according to the input driving current, to slide the shuttles 32 and 35 along the guides 32c and 35c. The shuttle drive section 65 and the shuttle motor MS are installed to each of the first shuttle 32 and the second shuttle 35, and the encoder EMS is installed to each shuttle motor MS. That is, the control device 60 controls an operation of the first shuttle 32 and an operation of the second shuttle 35 in an independent manner.

Further, a transport unit drive section 66 which includes a transport motor drive section 66a, two first elevating motor drive sections 66b and 66c, a second elevating motor drive section 66d, and two valve drive sections 66e and 66f is connected to the control device 60.

An encoder EMA which detects the rotation position of a transport motor MA is connected to the transport motor drive section 66a. The transport motor drive section 66a generates a driving current of the transport motor MA on the basis of a position command input from the control device 60 and the rotation position input from the encoder EMA, and outputs the driving current to the transport motor MA. The transport motor MA rotates according to the input driving current, to reciprocate the second elevating mechanism 51 along the transport guide 31. The transport motor drive section 66a is installed to each of the first transport unit 34 and the second transport unit 36, and the encoder EMA is installed to each of the first transport unit 34 and the second transport unit 36.

An encoder E52M which detects the rotation position of the first elevating motor 52M is connected to the first elevating motor drive section 66b. The first elevating motor drive section 66b generates a driving current of the first elevating motor 52M on the basis of a position command input from the control device 60 and the rotation position input from the encoder E52M, and outputs the driving current to the first elevating motor 52M. The first elevating motor 52M rotates according to the input driving current, to move up and down the lower end portion of the first elevating mechanism 52 with respect to the base 11. The first elevating motor drive section 66b is installed to each of the first transport unit 34 and the second transport unit 36, and the encoder E52M is installed to each of the first transport unit 34 and the second transport unit 36.

An encoder E53M which detects the rotation position of the first elevating motor 53M is connected to the first elevating motor drive section 66c. The first elevating motor drive section 66c generates a driving current of the first elevating motor 53M on the basis of a position command input from the control device 60 and the rotation position input from the encoder E53M, and outputs the driving current to the first elevating motor 53M. The first elevating motor 53M rotates according to the input driving current, to move up and down the lower end portion of the first elevating mechanism 53 with respect to the base 11. The first elevating motor drive section 66c is installed to each of the first transport unit 34 and the second transport unit 36, and the encoder E53M is installed to each of the first transport unit 34 and the second transport unit 36.

In this way, the control device 60 controls driving of the first elevating motor 52M and driving of the first elevating motor 53M in an independent manner.

An encoder E51M which detects the rotation position of the second elevating motor 51M is connected to the second elevating motor drive section 66d. The second elevating motor drive section 66d generates a driving current of the second elevating motor 51M on the basis of a position command input from the control device 60 and the rotation position input from the encoder E51M, and outputs the driving current to the second elevating motor 51M. The second elevating motor 51M rotates according to the input driving current, to move up and down the lower end portion of the second elevating mechanism 51 with respect to the base 11. The second elevating motor drive section 66d is installed to each of the first transport unit 34 and the second transport unit 36, and the encoder E51M is installed to each of the first transport unit 34 and the second transport unit 36.

A suction valve SV2 and a leak valve DV2 which are installed in the gripping section 52a of the first elevating mechanism 52 are connected to the valve drive section 66e. The valve drive section 66e generates a driving signal of the suction valve SV2 on the basis of an opening/closing command of the suction valve SV2 input from the control device 60, and outputs the driving signal to the suction valve SV2. Further, the suction valve SV2 performs an opening/closing operation according to the input driving signal, to thereby suction the electronic parts T using a predetermined suction force. Further, the valve drive section 66e generates a driving signal of the leak valve DV2 on the basis of an opening/closing command of the leak valve DV2 input from the control device 60, and outputs the driving signal to the leak valve DV2. The leak valve DV2 performs an opening/closing operation according to the input driving signal, to thereby transfer compressed air through the gripping section 52a of the first elevating mechanism 52. The suction valve SV2 and the leak valve DV2 are installed to each of the first transport unit 34 and the second transport unit 36, and the valve drive section 66e is installed to each of the first transport unit 34 and the second transport unit 36.

A suction valve SV3 and a leak valve DV3 which are installed in the gripping section 53a of the first elevating mechanism 53 are connected to the valve drive section 66f. The valve drive section 66f generates a driving signal of the suction valve SV3 on the basis of an opening/closing command of the suction valve SV3 input from the control device 60, and outputs the driving signal to the suction valve SV3. Further, the suction valve SV3 performs an opening/closing operation according to the input driving signal, to thereby suction the electronic parts T using a predetermined suction force. Further, the valve drive section 66f generates a driving signal of the leak valve DV3 on the basis of an opening/closing command of the leak valve DV3 input from the control device 60, and outputs the driving signal to the leak valve DV3. The leak valve DV3 performs an opening/closing operation according to the input driving signal, to thereby transfer compressed air through the gripping section 53a of the first elevating mechanism 53. The suction valve SV3 and the leak valve DV3 are installed to each of the first transport unit 34 and the second transport unit 36, and the valve drive section 66f is installed to each of the first transport unit 34 and the second transport unit 36.

That is, the control device 60 controls an operation of the first transport unit 34 and an operation of the second transport unit 36 in an independent manner.

Further, a tester 69 is electrically connected to the control device 60. When the electronic parts T are disposed at the inspection position of the test head 33 using the first transport unit 34 or the second transport unit 36, the control device 60 outputs a signal indicating inspection starting to the tester 69. The tester 69 receives an inspection starting signal, and then, starts inspection of the electronic parts T. If the inspection ends, the tester 69 outputs the inspection result and a signal indicating inspection ending to the control device 60.

### Operation State of Handler

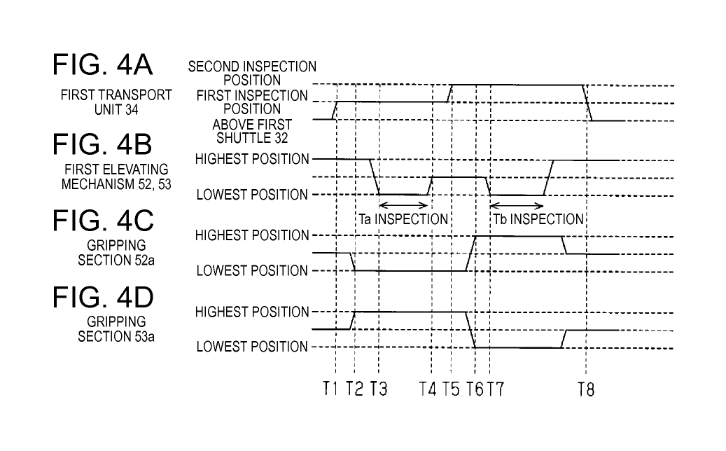

Next, with respect to an operation state of the handler 10 having the above-described configuration, an operation state of the first transport unit 34 will be mainly described with reference to FIGS. 4A to 4D to FIG. 13. The overall operations to be described below are performed by the respective drive sections on the basis of the various commands from the control device 60.

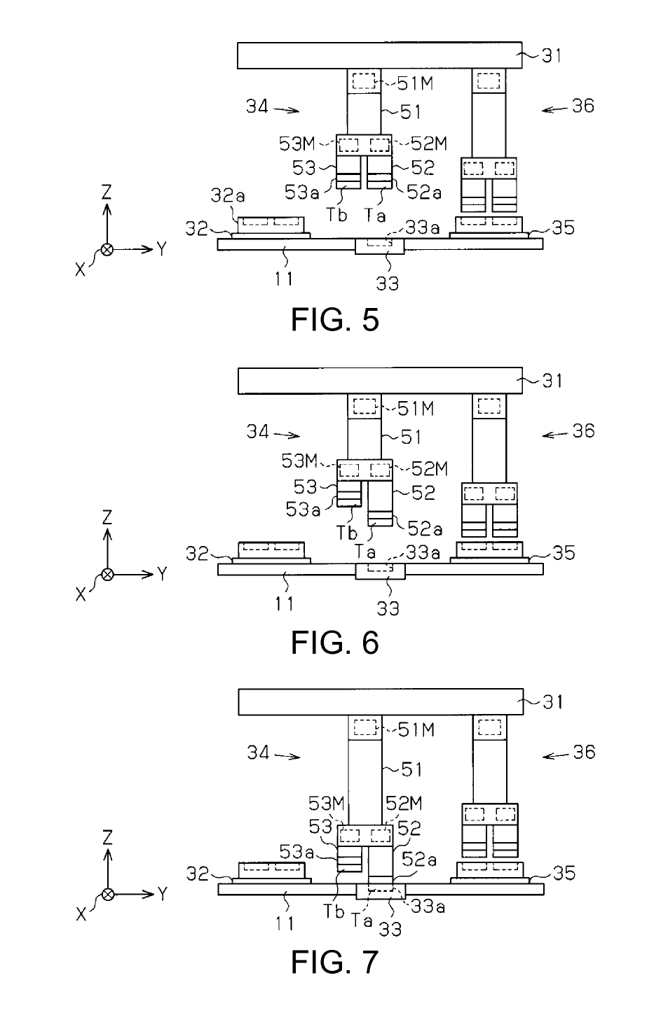

With respect to the operation state of the first transport unit 34, FIG. 4A schematically illustrates transition of the position of the first transport unit 34 in the Y direction with respect to the base 11, and FIG. 4B schematically illustrates transition of the position of the first elevating mechanisms 52 and 53 in the Z direction with respect to the base 11, due to driving of the second elevating motor 51M. Similarly, FIG. 4C schematically illustrates transition of the position of the gripping section 52a in the Z direction with respect to the base 11, due to driving of the first elevating motor 52M, and FIG. 4D schematically illustrates transition of the position of the gripping section 53a in the Z direction with respect to the base 11, due to driving of the first elevating motor 53M. Further, FIGS. 5 to 13 illustrate the arrangement of the first transport unit 34 at each timing chart shown in FIGS. 4A to 4D.

Firstly, the first transport unit 34 grips in a lump the electronic parts T before inspection which are disposed in the supply shuttle tray 32a on the first shuttle 32 by each of the gripping sections 52a and 53a, and then moves up to a first inspection position in the Y direction at time T1. The first inspection position is a position where an electronic part Ta gripped by the gripping section 52a of the first elevating mechanism 52 is disposed directly above the inspection pocket 33a of the test head 33 (see FIG. 5). At the time T1, the lower end portion of the second elevating mechanism 51, that is, the first elevating motors 52M and 53M which are built in the lower end portion, are disposed at the highest position of a movable range thereof in the Z direction. Further, the lower end portions of the first elevating mechanisms 52 and 53, that is, the gripping sections 52a and 53a which are connected to the lower end portions are disposed at an intermediate position of a movable range thereof in the Z direction.

Next, at time T2, as the first elevating motor 52M is driven, the gripping section 52a descends to the lowest position in the movable range of the gripping section 52a by the driving of the first elevating motor 52M. Further, at this time, as the first elevating motor 53M is driven, the gripping section 53a ascends up to the highest position in the movable range of the gripping section 53a by the driving of the first elevating motor 53M (see FIG. 6).

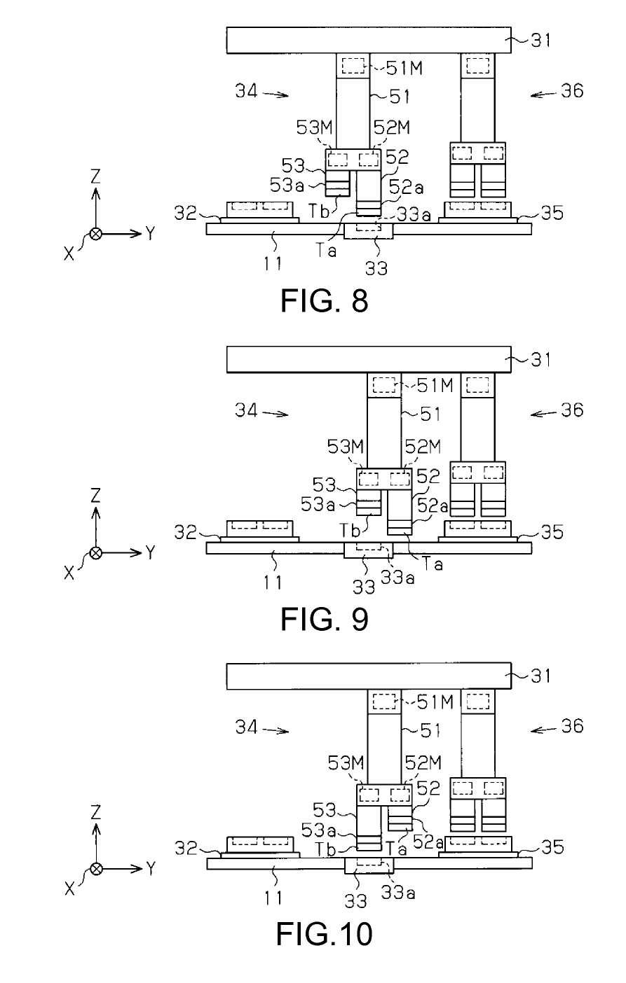

Then, at time T3, as the second elevating motor 51M is driven, the lower end portion of the second elevating mechanism 51, that is, the first elevating motors 52M and 53M which are built in the lower end portion, descend to the lowest position of the movable range. Accordingly, the gripping sections 52a and 53a descend together, and only the electronic part Ta gripped by the gripping section 52a is inserted into the inspection pocket 33a of the test head 33 (see FIG. 7). Further, the electronic part Ta is pressed by the driving of the first elevating motor 52M and the second elevating motor 51M, and then, the electronic part Ta is supplied for inspection in the tester 69. Here, since the gripping section 53a is disposed above the gripping section 52a, it is possible to suppress an electronic part Tb gripped by the gripping section 53a from interfering with the test head 33 or various peripheral parts. If the inspection of the electronic part Ta in the tester 69 is terminated, at time T4, the second elevating motor 51M is driven, the thus, the lower end portion of the second elevating mechanism 51, that is, the first elevating motors 52M and 53M which are built in the lower end portion ascend (see FIG. 8). Here, the lower end portion of the second elevating mechanism 51 do not ascend up to the highest position of the movable range, and the electronic part Ta which ascends together with the ascent of the lower end portion of the second elevating mechanism 51 is pulled out of the inspection pocket 33a and ascends up to a position where the electronic part Ta does not interfere with the test head 33 or various peripheral parts. Thus, it is possible to reduce the movement distance and movement time of the lower end portion of the second elevating mechanism 51.

Next, at time T5, the first transport unit 34 moves up to a second inspection position in the Y direction. The second inspection position is a position where the electronic part Tb gripped by the gripping section 53a of the first elevating mechanism 53 is disposed directly above the inspection pocket 33a of the test head 33 (see FIG. 9).

Then, at time T6, as the first elevating motor 52M is driven, the gripping section 52a ascends up to the highest position in the movable range of the gripping section 52a by the driving of the first elevating motor 52M. At this time, as the first elevating motor 53M is driven, the gripping section 53a descends to the lowest position in the movable range of the gripping section 53a by the driving of the first elevating motor 53M (see FIG. 10).

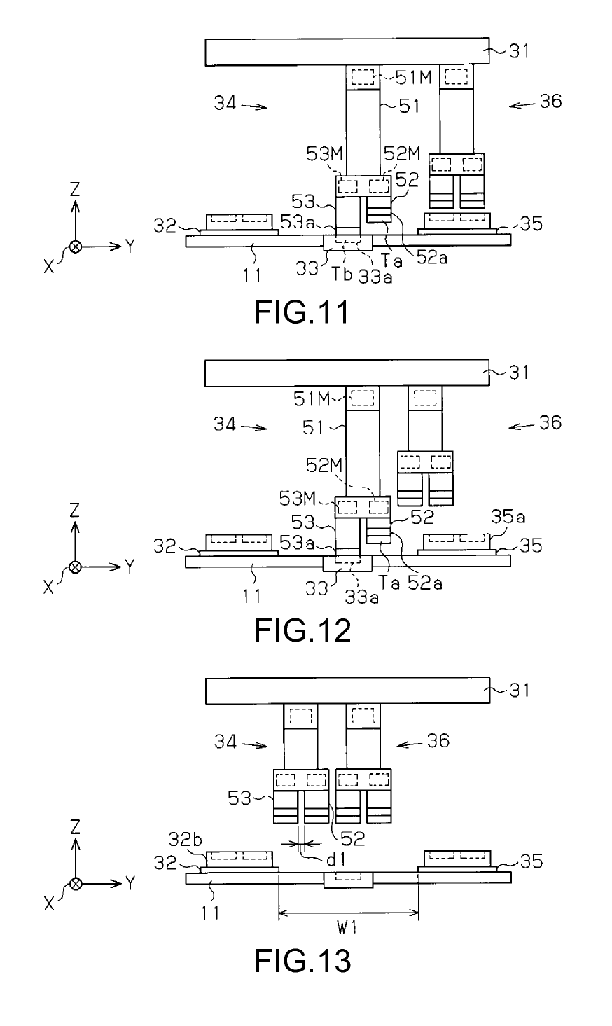

Next, at time T7, as the second elevating motor 51M is driven, the lower end portion of the second elevating mechanism 51, that is, the first elevating motors 52M and 53M which are built in the lower end portion descend to the lowest position of the movable range. Accordingly, the gripping sections 52a and 53a descend together, and only the electronic part Tb gripped by the gripping section 53a is inserted into the inspection pocket 33a of the test head 33 (see FIG. 11). Further, the electronic part Tb is pressed by the driving of the first elevating motor 53M and the second elevating motor 51M, and then, the electronic part Tb is supplied for inspection in the tester 69. Here, since the gripping section 52a is disposed above the gripping section 53a, it is possible to suppress the electronic part Ta gripped by the gripping section 52a from interfering with the test head 33 or various peripheral parts.

In this way, the electronic parts Ta and Tb gripped by the first transport unit 34 are sequentially supplied for inspection in the part inspection apparatus.

Hereinafter, an operation state of the second transport unit 36 during the electronic parts T are supplied for inspection by the first transport unit 34 will be described.

While the electronic parts T are supplied for inspection using the first transport unit 34, the second transport unit 36 ejects the electronic parts T after inspection to the recovery shuttle tray 35b, and supplies the electronic parts T before inspection from the supply shuttle tray 35a (not shown in FIGS. 5 to 11, for simplicity of illustration). If the supply of the electronic parts T is complete, as shown in FIG. 12, the second transport unit 36 moves close to the first transport unit 34 and then waits at a position closest to the first transport unit 34 in the movable range of the second transport unit 36 in the Y direction.

Subsequently, the operation states of the first transport unit 34 and the second transport unit 36 after the inspection of the electronic parts Ta and Tb gripped by the first transport unit 34 has been completed will be described.

If the inspection of the electronic part Tb using the tester 69 is terminated, as shown in FIG. 4, in the first transport unit 34, as the second elevating motor 51M is driven, the lower end portion of the second elevating mechanism 51, that is, the first elevating motors 52M and 53M which are built in the lower end portion ascend up to the highest position of the movable range. Further, as the first elevating motor 52M is driven, the gripping section 52a descends to the previous intermediate position, and as the first elevating motor 53M is driven, the gripping section 53a ascends up to the previous intermediate position. Further, at time T8, the first transport unit 34 moves above the first shuttle 32 in the Y direction. Here, the second transport unit 36 which is adjacent to the first transport unit 34 in standby moves in synchronization with the movement of the first transport unit 34. Further, the second transport unit 36 moves up to a predetermined position in the Y direction, that is, a position where an electronic part T which is an initial inspection target among the electronic parts T gripped by the second transport unit 36 is disposed immediately above the inspection pocket 33a of the test head 33 (see FIG. 13).

Then, in a similar way to the case of the first transport unit 34, an operation of supplying the electronic parts T using the second transport unit 36 for inspection is performed, and ejection of the electronic parts T after inspection and supply of the electronic parts T before inspection are performed in the first transport unit 34. In this way, while one transport unit supplies the electronic parts for inspection, ejection and supply of the electronic parts T are repeated in the other transport unit.

In this way, in the transport units 34 and 36, the entire of two first elevating mechanisms 52 and 53 having the gripping sections 52a and 53a and two first elevating motors 52M and 53M corresponding thereto moves up and down by the driving of the one second elevating motor 51M. Thus, an elevating mechanism which moves up and down the first elevating mechanisms 52 and 53 is communalized by the one second elevating mechanism 51, and thus, the configurations of the transport units 34 and 36 are simplified, and the sizes or the weights of the transport units 34 and 36 are decreased. Thus, the movement speeds of the transport units 34 and 36 in transportation of the electronic parts T are enhanced. Further, each of the transport units 34 and 36 includes two gripping sections 52a and 53a, and when the electronic parts T gripped by the gripping sections 52a and 53a are supplied for inspection, the gripping section which grips the electronic part T which is an inspection target descends, and the other gripping section ascends. Thus, it is possible to supply the electronic parts T for inspection a plurality of times without intervention of ejection and supply of the electronic parts T on the way using each of the transport units 34 and 36, and it is thus possible to efficiently transport the electronic parts T to the test head 33.

Further, while one transport unit supplies the electronic parts T for inspection, the other transport unit grips the electronic parts T before inspection, and then moves close to the transport unit in operation in standby. Thus, it is also possible to efficiently transport the electronic parts T to the test head 33. Here, with respect to the transport unit during waiting, if the waiting is performed after the operation of moving down the gripping section which grips the electronic part T which is the initial inspection target and moving up the other gripping section is complete, it is possible to further efficiently transport the electronic parts T.

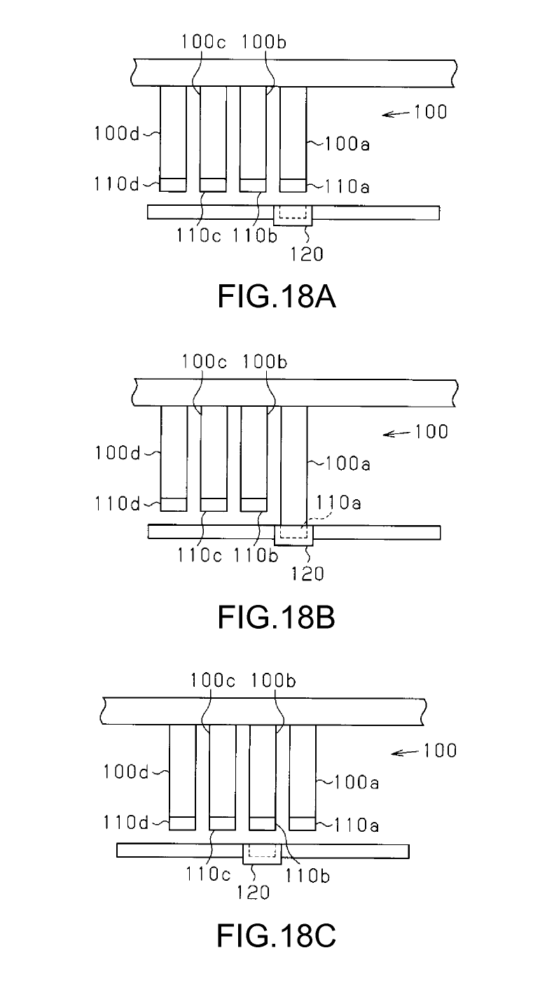

Further, when the inspection is performed four times altogether using the tester 69, two transport units 34 and 36 each of which includes two gripping sections 52a and 53a are disposed on opposite sides of the test head 33. Thus, compared with a configuration in which the electronic parts T are supplied for inspection using one transport unit which includes four gripping sections shown in FIGS. 18A to 18C, it is possible to reduce the transport distance of one transport unit in the Y direction which is necessary for inspection. Thus, as shown in FIG. 13, it is possible to decrease the width W1 between the first shuttle 32 and the second shuttle 35, thereby resulting in miniaturization of the entire hander 10.

In this regard, as shown in FIG. 13, as the interval d1 between the two first elevating mechanisms 52 and 53 is small, it is possible to achieve miniaturization of the transport units 34 and 36, and to further decrease the width W1. Thus, in decreasing the transport distance and transport time of the transport units 34 and 36 in the transport operation of the electronic parts T to the test head 33 of the transport units 34 and 36, it is preferable that the interval d1 be a minimum value in a range where the elevation of each of two first elevating mechanisms 52 and 53 is not hindered.

In description of the operation state of the first transport unit 34, for ease of description, with respect to the movement of the first transport unit 34 in the Y direction, the movement of the lower end portion in the second elevating mechanism 51 in the Z direction, the movements of the end portions in the first elevating mechanisms 52 and 53 in the Z direction, it is assumed that one directional movement ends and then the next directional movement starts. However, if the different directional movements are to be performed at the same time, it is possible to decrease the time taken for the transportation of the transport units 34 and 36. In this case, movement traces that the gripping sections 52a and 53a in the first unit 34 move form an arch shape.

Further, each of two transport units 34 and 36 includes two gripping sections 52a and 53a and the first elevating motors 52M and 53M corresponding thereto, but may include three or more gripping sections and first elevating motors corresponding thereto. In this case, when the electronic part T gripped by each gripping section is supplied for inspection, the first elevating motor corresponding to each gripping section is driven so that one gripping section which grips the electronic part T which is the inspection target descends and the other gripping section ascends. Further, by performing elevation of the gripping sections according to the movement of the transport units 34 and 36 in the Y direction, the electronic parts T are sequentially supplied for inspection. As described above, according to the present embodiment, it is possible to obtain the following effects.

(1) The transport units 34 and 36 of the handler 10 include the plurality of first elevating motors 52M and 53M which respectively elevate the plurality of gripping sections 52a and 53a which grip the electronic parts T and one second elevating motor 51M which elevates the entire of plurality of first elevating motors 52M and 53M. Accordingly, since the second elevating motor 51M which elevates the entire of the first elevating motors 52M and 53M and the first elevating mechanisms 52 and 53 is single, the configuration of the transport unit is simplified. Further, it is possible to decrease the sizes or weights of the transport units, and thus, it is possible to enhance the movement speed of the transport units in transportation of the electronic parts T, and to efficiently transport the electronic parts T.

(2) Under the control of the control device 60, a part of the plurality of first elevating motors 52M and 53M are driven to descend, and the remaining first elevating motor is driven to ascend. Accordingly, it is possible to supply the electronic parts T which are inspection units for inspection a plurality of times by one transport unit which includes the plurality of gripping sections, without intervention of ejection and supply of the electronic parts T on the way. Thus, it is thus possible to efficiently transport the electronic parts T to the test head 33, and to enhance inspection efficiency of the electronic parts T in the part inspection apparatus.

(3) Further, compared with an elevation state where the other first elevating mechanism is driven to descend or is not driven when one first elevating mechanism is driven to descend, according to the above-described elevation state, the respective positions of the plurality of the first elevating mechanisms 52 and 53 are spaced from each other in the elevating direction. Thus, even in a case where a portion which interferes with descent of one gripping section in a direction where the one gripping section descends is present on the base 11, only the one gripping section can be driven to ascend, and the other gripping section can be driven to descend, to thereby avoid interference with such a portion.

(4) The movement of the transport unit in the Y direction and the movement of each section of the transport unit in the Z direction are performed using the transport motor, the first elevating motors 52M and 53M, and the second elevating motor 51M. Thus, with respect to driving of each section, it is possible to perform high speed driving or arch driving. Accordingly, it is possible to efficiently transport the electronic parts T.

(5) The handler 10 includes two transport units 34 and 36, and under the control of the control device 60, until the connection operation of the electronic part T to the test head 33 using one transport unit is terminated, the other transport unit is adjacent to the one transport unit in standby. Accordingly, the two transport units 34 and 36 can continuously transport the electronic parts T to the test head 33 with high accuracy, and thus, it is possible to enhance inspection efficiency of the electronic parts T in the part inspection apparatus.

### Second Embodiment

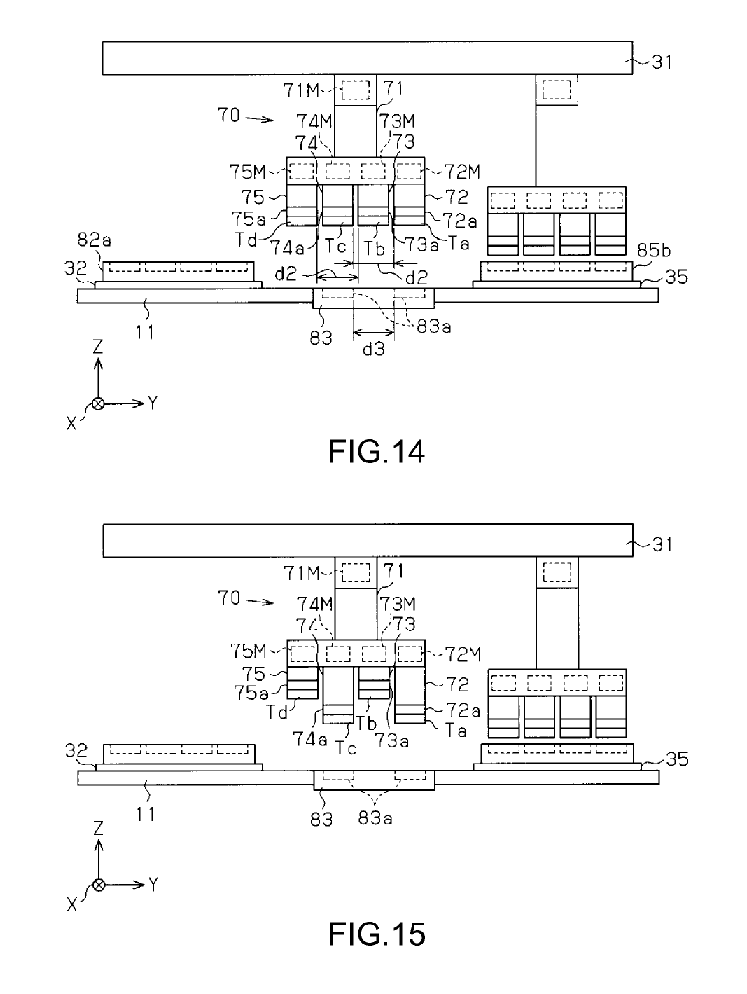

Herein, a second embodiment in which a handler and a part inspection apparatus according to the invention are specified will be described with reference to FIGS. 14 to 17. The handler and the part inspection device according to the present embodiment have the same basic configurations as in the first embodiment. Here, in the present embodiment, since the number of first elevating mechanisms, the number of first elevating motors and the number of gripping sections included in a transport unit of the handler, and their operation states are different from the first embodiment, the different points will be mainly described hereinafter.

### Configuration of Transport Unit

As shown in FIG. 14, a second elevating mechanism 71 is connected to a transport guide 31 to be able to reciprocate along a transport guide 31. A plate-shaped connection section which is widened along a mounting surface 11a is formed in a lower end portion of the second elevating mechanism 71, and four first elevating mechanisms 72, 73, 74 and 75 are commonly connected to the connection section on the side of the mounting surface 11a.

Gripping sections 72a, 73a, 74a and 75a which are end effectors capable of adhering and gripping electronic parts T using vacuum suction, for example, are connected to the respective lower end portion of the first elevating mechanisms 72 to 75. In a similar way to the first embodiment, the respective gripping sections 72a to 75a are connected to nozzles, a suction pump connected to the nozzles, leak valves which supply compressed air to the nozzles, and the like, for example. First elevating motors 72M, 73M, 74M and 75M are built in the connection section which is the lower end portion of the second elevating mechanism 71. Further, as the first elevating motor 72M rotates forward or reversely, the lower end portion of the first elevating mechanism 72 ascends or descends with respect to the base 11, and as the first elevating motor 73M rotates forward or reversely, the lower end portion of the first elevating mechanism 73 ascends or descends with respect to the base 11. Similarly, as the first elevating motor 74M rotates forward or reversely, the lower end portion of the first elevating mechanism 74 ascends or descends with respect to the base 11, and as the first elevating motor 75M rotates forward or reversely, the lower end portion of the first elevating mechanism 75 ascends or descends with respect to the base 11. The first elevating motors 72M to 75M are controlled to be able to be driven by the control device 60 in an independent manner. Further, a second elevating motor 71M is built in an upper portion of the second elevating mechanism 71, and as the second elevating motor 71M rotates forward or reversely, the lower end portion of the second elevating mechanism 71 ascends or descends with respect to the base 11. That is, as the second elevating motor 71M is driven, the entire of the first elevating motors 72M to 75M, the first elevating mechanisms 72 to 75, and the gripping sections 72a to 75a ascends or descends. A first transport unit is configured by the second elevating mechanism 71, the second elevating motor 71M, the first elevating mechanisms 72 to 75, and the first elevating motors 72M to 75M. A second elevating section in the first transport section is configured by the second elevating mechanism 71 and the second elevating motor 71M, and a first elevating section in the first transport section is configured by the first elevating mechanisms 72 to 75 and the first elevating motors 72M to 75M.

Further, a second transport unit has the same configuration, and a second transport section is configured by a second elevating mechanism, a second elevating motor, four first elevating mechanisms, and four first elevating motors in the second transport unit. Further, a second elevating section in the second transport section is configured by a second elevating mechanism and a second elevating motor in the second transport unit, and a first elevating section in the second transport section is configured by the first elevating mechanisms and the first elevating motors.

Further, in the present embodiment, inspection pockets 83a capable of simultaneously accommodating three rows of electronic parts T in the X direction and two rows of electronic parts T in the Y direction are concavely installed in an inspection socket installed on the upper surface of a test head 83. Further, in supply shuttle trays 82a and 85a and recovery shuttle trays 82b and 85b, three rows of electronic parts T in the X direction and four rows of electronic parts T in the Y direction are accommodated in a matrix form. Further, each of the gripping sections 72a to 75a of the first transport unit 70 is configured to be able to simultaneously grip three rows of the electronic parts T in the X direction and one row of the electronic parts T in the Y direction. That is, the first transport unit 70 includes four gripping sections 72a to 75a, and thus, can grip the electronic parts T corresponding to two times the number of electronic parts capable of being inspected by a tester 69 at a time.

### Operation State of Handler

Next, with respect to an operation state of the handler 10 having the above-described configuration, an operation state of the first transport unit 70 will be mainly described with reference to FIGS. 14 to 17. All the operations described below are performed by respective driving sections on the basis of various commands from the control device 60.

Firstly, the first transport unit 70 grips in a lump the electronic parts T before inspection which are disposed in the supply shuttle tray 82a on a first shuttle 32 by each of the gripping sections 72a to 75a, and then moves up to a first inspection position in the Y direction as shown in FIG. 14. The first inspection position is a position where an electronic part Ta gripped by the gripping section 72a of the first elevating mechanism 72 and an electronic part Tc gripped by the gripping section 74a of the first elevating mechanism 74 are disposed directly above the inspection pockets 83a of the test head 83. Under the assumption that such an arrangement state is possible, the widths in the Y direction in the transport unit 70 and the tester head 83 are configured as follows. That is, the interval between the electronic part Ta gripped by the gripping section 72a and the electronic part Tc gripped by the gripping section 74a is set to d2, and the interval between an electronic part Tb gripped by the gripping section 73a and an electronic part Td gripped by the gripping section 75a is set to d2. Further, the transport unit 70 and the test head 83 are configured so that these intervals d2 and the interval d3 between two rows of the inspection pockets 83a installed in the test head 83 in the Y direction are the same. Next, as shown in FIG. 15, as two first elevating motors 72M and 74M are driven, two gripping sections 72a and 74a descend to the lowest position of a movable range through the first elevating motors 72M and 74M. On the other hand, as the other two first elevating motors 73M and 75M are driven, gripping sections 73a and 75a ascend up to the highest position of a movable range through the first elevating motors 73M and 75M.

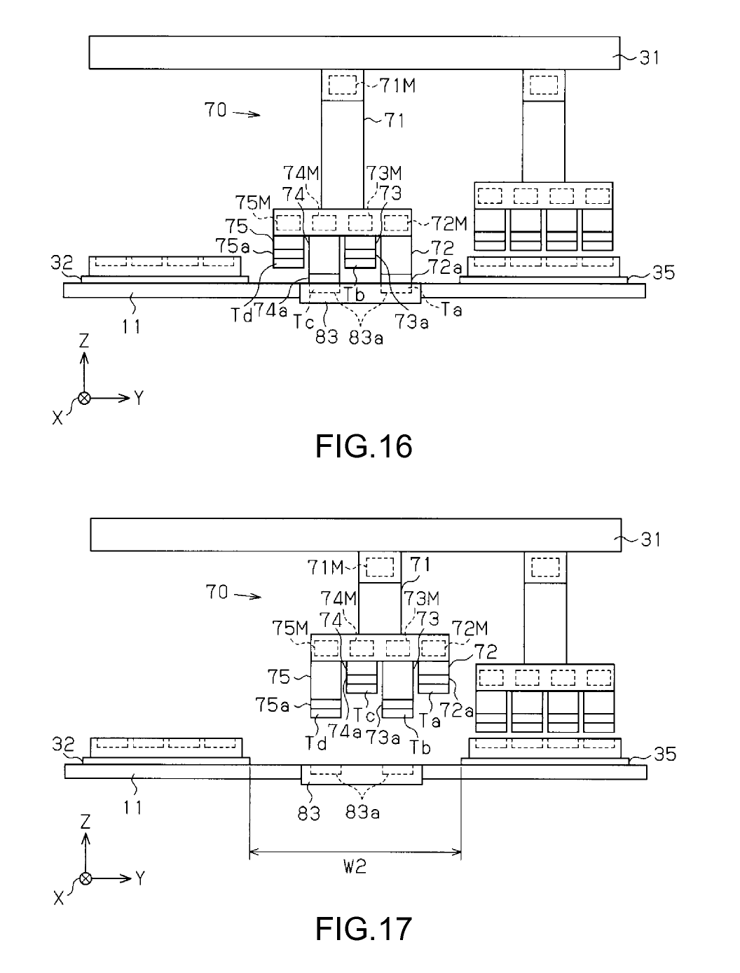

Then, as shown in FIG. 16, as the second elevating motor 71 is driven, the lower end portion of the second elevating mechanism 71, that is, the first elevating motors 72M to 75M which are built in the lower end portion, descend to the lowest position of the movable range. Accordingly, the gripping sections 72a to 75a descend, and only the electronic parts Ta and Tc gripped by the two gripping sections 72a and 74a are inserted into the inspection pockets 83a of the test head 83. Then, the electronic parts Ta and Tc are supplied for inspection in the tester 69. Here, since the other two gripping section 73a and 75a are disposed above the gripping sections 72a and 74a, it is possible to suppress the electronic parts Tb and Td gripped by the gripping sections 73a and 75a from interfering with the test head 83 or various peripheral parts.

If the inspection of the electronic parts Ta and Tc in the tester 69 is terminated, the second elevating motor 71M is driven, the thus, the lower end portion of the second elevating mechanism 71, that is, the first elevating motors 72M to 75M which are built in the lower end portion ascend. Further, the first transport unit 70 moves up to a second inspection position in the Y direction. The second inspection position is a position where the electronic part Tb gripped by the gripping section 73a of the first elevating mechanism 73 and the electronic part Td gripped by the gripping section 75a of the first elevating mechanism 75 are disposed directly above the inspection pockets 83a of the test head 83.

Then, as shown in FIG. 17, as the two first elevating motors 72M and 74M are driven, the two gripping sections 72a and 74a ascend up to the highest position in the movable range. On the other hand, as the two first elevating motors 73M and 75M are driven, the other two gripping sections 73a and 75a descend to the lowest position in the movable range.

Further, as the second elevating motor 71M is driven, the lower end portion of the second elevating mechanism 71, that is, the first elevating motors 72M to 75M which are built in the lower end portion descend to the lowest position in the movable range, and the electronic parts Tb and Td gripped by the two gripping sections 73a and 75a are supplied for inspection in the tester 69.

In this way, one transport unit 70 includes four gripping sections 72a to 75a, and the gripping sections which grip the electronic parts T which are the inspection targets descend and the other gripping sections ascend so that when the electronic parts T gripped by the respective gripping sections 72a to 75a are supplied for inspection, the elevation states of adjacent gripping sections are different from each other. That is, the respective first elevating motors 72M to 75M are driven so that the elevation states of the adjacent first elevating mechanisms 72 to 75 are different from each other. Thus, even though portions on the base 11 which become destinations where the electronic parts T descend are disposed at an interval, as described above, if such an interval corresponds to the width of the one first elevating mechanism, it is possible to move down the electronic parts T at a time to the plurality of portions which are the descending destinations. Accordingly, it is possible to decrease transport chances or transport distance per one transport unit which is necessary for inspection, and thus, it is possible to decrease the width W2 between the first shuttle 32 and the second shuttle 35. Thus, when the transport unit 70 performs the operation of transporting the electronic parts T to the test head 83, it is possible to decrease the time necessary for the operation.

While the electronic parts T are supplied for inspection by the first transport unit 70, the second transport unit performs ejection of the electronic parts T after inspection and supply of the electronic parts T before inspection, and then moves close to the first transport unit 70. Then, the second transport unit waits at a position closest to the first transport unit 70 in the movable range of the second transport unit in the Y direction. Further, if the inspection of the electronic parts T gripped by the first transport unit 70 is completely terminated, the first transport unit 70 and the second transport unit move in the Y direction in synchronization with each other, and then, an operation of supplying the electronic parts gripped by the second transport unit for inspection is performed.

In the present embodiment, with respect to movements of the respective sections in the transport unit, if the respective sections in the transport unit move in different directions at the same time so that the movement traces become an arch shape, it is possible to decrease the time taken for the movement of the transport unit.

In the present embodiment, the one transport unit 70 includes four gripping sections 72a to 75a and the first elevating mechanisms 72 to 75 which are connected to the respective four gripping sections 72a to 75a, but may include four or more gripping sections and first elevating mechanisms corresponding to the respective gripping sections. In this case, if the respective first elevating sections are driven so that the elevation states of the adjacent first elevating mechanisms are different from each other, it is possible to decrease the transport distance and transport time in the transport operation of the electronic parts T to the test head 83 of the transport unit.

As described above, according to the present embodiment, the following effects are obtained, in addition to the effects of (1) to (5) according to the first embodiment.

(6) The transport unit includes four first elevating motors 72M to 75M, and drives the first elevating motors 72M to 75M so that the elevation states of adjacent first elevating mechanisms 72 to 75 are different from each other under the control of the control device 60. Accordingly, it is possible to decrease the transport distance and transport time in the transport operation of the electronic parts T to the test head 83. Thus, it is possible to efficiently transport the electronic parts T to the test head 83, and to enhance the inspection efficiency of the electronic parts T in the part inspection apparatus.

The above-described embodiments may be appropriately modified for realization as follows.

The number of inspection pockets or the arrangement state thereof in the test heads 33 or 83, the number of electronic parts T accommodated in the supply shuttle trays 32a or 82a and the recovery shuttle tray 35b or 85b or the arrangement state thereof are not limited to the cases of the above-described embodiments, which are arbitrary.

The number of electronic parts T capable of being gripped by the gripping section in the transport unit may be one or a plurality. Further, in a case where the gripping section grips the plurality of electronic parts, the arrangement state of the plurality of electronic parts gripped by the gripping section may be a state where the plurality of electronic parts are disposed in a row or a state where the plurality of electronic parts are disposed in a matrix form.

Further, the number of electronic parts T gripped by the gripping section or the arrangement state thereof does not limit the number of the inspection pockets in the test head 33 or 83 or the arrangement state thereof, and the number of electronic parts T accommodated in the supply shuttle tray 32a or 82a and the recovery shuttle tray 35b or 85b or the arrangement state thereof. That is, in any configuration in which the gripping sections are independently elevated by the plurality of respective first elevating motors corresponding to the plurality of respective gripping sections, the number of electronic parts T gripped by the gripping section or the arrangement state thereof is arbitrary.

The first elevating motors, the first elevating mechanisms and the gripping sections may be configured by one exchangeable unit. Accordingly, it is possible to easily adjust the number of electronic parts T gripped by the gripping section, the interval thereof or the like, to thereby enhance versatility as the handler.

In the above-described embodiments, the position control of the gripping section of the first elevating mechanism is performed using three positions of the highest position, the intermediate position and the lowest position, but may be performed using two positions of the highest position and the lowest position. In this case, the supply and ejection of the electronic parts T may be performed using the positions of all the gripping sections in the transport unit as the highest position or the lowest position. Further, in a case where the position control of the gripping section is performed using two positions, movements of the respective sections in the transport unit in the Z direction may be performed by a pneumatic pressure cylinder or the like.

In the above-described embodiments, two different transport units are provided, but the number of the transport units may be one, or may be three or more.

In the above-described embodiments, the handler is provided in the part inspection apparatus, but is not limited thereto and may be provided in various apparatuses or the like which should perform an operation of transporting a transport target on a base.

The entire disclosure of Japanese Patent Application No. 2011-195435, filed Sep. 7, 2011 is expressly incorporated by reference herein.

What is claimed is:

1. A handler including a transport section which transports a transport target onto a base,
wherein the transport section comprises:
a plurality of first elevating sections which are connected to a gripping section which grips the transport target, and moves up and down the gripping section with respect to the base; and
a second elevating section which moves up and down the plurality of connected first elevating sections at a time with respect to the base.

2. The handler according to claim 1, further comprising:
a control section which controls transport of the transport section,
wherein the control section drives a part of the plurality of first elevating sections to descend and drives the remaining part thereof to ascend, at the same time.

3. The handler according to claim 1, further comprising:
a control section which controls transport of the transport section,
wherein the transport section includes four or more first elevating sections, and
wherein the control section drives the plurality of first elevating sections so that elevating directions of the first elevating sections which are adjacent to each other are different from each other.

4. The handler according to claim 1,
wherein a time when a first elevating motor installed in the first elevating section is driven to move the first elevating section and a time when a second elevating motor installed in the second elevating section is driven to move the second elevating section can be different from each other.

5. The handler according to claim 1, further comprising:
a control section which controls transport of the transport section; and
two transport sections,
wherein until a connection operation of the transport target to a connection destination of the transport target through one transport section is terminated, the control section makes the other transport section adjacent to the one transport section in standby.

6. A part inspection apparatus comprising:
a tester which has an inspection socket installed in an opening portion of a base; and
at least one transport section which transports an electronic part to the inspection socket on the base,
wherein the transport section includes
a plurality of first elevating sections which are respectively connected to a plurality of gripping sections which grip the electronic part and respectively move up and down the plurality of gripping sections with respect to the inspection socket; and
a single second elevating section which is connected to all the plurality of first elevating sections and moves up and down all the plurality of first elevating sections with respect to the inspection socket.
